(19) United States
(12) Patent Application Publication
(10) Pub. No.: US 2026/0116122 A1
(43) Pub. Date: Apr. 30, 2026

(54) AN ANTITHEFT DEVICE FOR CAR WHEELS AND AN INSERT STRUCTURE THERETO

(71) Applicant: Rimgard Sweden AB, Solna (SE)

(72) Inventors: Marcus Ekström, Hägersten (SE); Lars Ivarsson, Stockholm (SE)

(21) Appl. No.: 19/164,820

(22) PCT Filed: Mar. 20, 2024
(86) PCT No.: PCT/US2024/020621

§ 371 Date: Sep. 12, 2025

Related U.S. Application Data
(60) Provisional application No. 63/453,309, filed on Mar. 20, 2023.

(51) Int. Cl. B60B 7/16; B60B 3/16; B60B 7/00; B60B 7/04; B60B 7/06; B60B 7/14

(52) U.S. Cl. CPC B60B 7/16; B60B 3/165; B60B 7/0013; B60B 7/04; B60B 7/066; B60B 7/14

(57) ABSTRACT

A simplified universal antitheft device for preventing unauthorized removal of vehicle wheels is provided. The device includes an insert structure comprising an insert ring and a support structure.

### FIELD OF THE INVENTION

The present disclosure relates to a technology for preventing unauthorized removal of vehicle wheels. More specifically, the disclosure relates to a universal simplified antitheft device preventing unauthorized access to wheel fasteners. More specifically the disclosure relates to an insert structure for an antitheft device.

### BACKGROUND OF THE INVENTION

Unauthorized removal of car parts, specifically alloy wheels, is a frequently occurring problem all over the world. Due to their high value, custom wheels and tire rims are examples of items frequently stolen. Accordingly, there is a great need for devices and techniques for protecting wheels from unauthorized removal.

There have been attempts to provide such protection. For example, U.S. Pat. Nos. 8,739,585 and 8,943,865 disclose antitheft devices for car wheels. These devices can be removed relatively easily by an experienced thief and thus do not provide a truly reliable wheel lock. U.S. Pat. No. 9,689,180 issued to the inventors of this application provides a device that provides secure antitheft device; however, the device requires relatively large number of parts. Other locking devices are provided in U.S. Pat. Nos. 11,541,686 and 11,524,522 to the inventors of this application. Both of these devices require a two-part insert structure for insertion in the wheel. Considering the great variety of car makes and models all over the world, there is a need for an improved wheel lock system that fits, without substantial adjustments to most car wheels. Moreover, there is a need to for a system that has fewer parts than the known solutions for reduction of production costs and increasing durability. With fewer components modification for different car models would also be easier.

### SUMMARY

In view of the above, the object of the present disclosure is to provide a technology to address at least some of the above concerns. The object of this disclosure is to provide an antitheft locking system to prevent unauthorized removal of car wheels with simpler, more economic, more durable and more reliable elements than in currently available solutions.

It is an object of this disclosure to provide an antitheft device for preventing unauthorized access to fasteners of a wheel of a vehicle, comprising:
a main module (105) adapted to be attached to the wheel, and configured to cover the fasteners of the wheel;
an insert structure comprising an insert ring (106) and a support structure (107),
   the insert ring having a central hole (109) and an outer (117) and an inner (116) circumference; wherein
   the inner circumference (116) of the ring is threaded, the threading being adapted to match threading of a center bolt (103) configured to adapt a cylindrical lock (101) adapted to prevent the center bolt (103) rotating relative to the insert structure when the cylindrical lock is in a locked position,
   the outer circumference (117) of the insert ring being elongated and defined by a short diameter being smaller than a diameter of a central bore (111) of the wheel, and a long diameter perpendicular to the short diameter and being larger than the diameter of the central bore (111), the insert ring thus having two elongated ends (112) opposite to each other, and optionally two grooves (113) opposite to each other in locations defined by the short diameter in between the elongated ends,
   the support structure (107) having two flat wing or loop like elements (107A) configured to extend outward from the outer circumference (117) of the insert ring (106) on opposite sides of the outer circumference (117) at locations defined by the short diameter,
the insert structure being configured to be inserted into the center bore of the wheel (111) in an angle such that a first elongated end is slipped under the hub wall (114) allowing the opposite elongated portion to be slipped under the hub wall and allowing the flat wing or loop like elements (107A) of the support structure to rest on an edge (115) of the central bore supporting the insert structure.

According to certain aspects of the invention, the insert structure is a wire bar having the flat wing or loop like elements (107A) at the ends of the bar, and wherein the wire bar is configured to be mounted underneath the insert ring (106), such that the flat wing or loop like elements extend outward from the outer circumference (117) of the insert ring (106) on opposite sides of the outer circumference at locations defined by the short diameter, and wherein the wire bar is preferably inserted into the grooves (113) on the outer circumference.

According to certain aspects the support structure is an integral part of the insert ring and consists of two flat wing or loop like elements extending outward from the outer circumference of the insert ring on opposite sides of the outer circumference at locations defined by the short diameter.

It is an object of this disclosure to provide an insert structure configured to be fitted into a center bore (111) of a vehicle wheel and to extend partially underneath a hub wall (114) for attaching a locking device preventing unauthorized access to the wheel fasteners, wherein the insert structure comprises:
an elongated insert ring (106) having a substantially flat upper surface, a round central hole (109), and an outer circumference (117) defined by a short diameter being smaller than a diameter of a central bore (111) of the wheel, and a long diameter being larger than the diameter of the central bore (111), and
   a support structure (107) configured to support the insert ring against an edge (115) of the center bore;
the central hole (109) being dimensioned to receive a center bolt (103) of the locking device, and having a threaded inner surface (110) configured to match a threading of the center bolt;
the support structure comprising two substantially flat wing or loop like elements (107A) arranged on the outer circumference (117) of the insert ring opposite to each other at locations defined by a short diameter of the outer circumference (117) and extending outward away from the central hole (109) of the insert ring; and wherein
the insert structure is configured to be inserted above the center bore (111) in an angled position by inserting one of the elongated ends (112) first such that the inserted end slips underneath the hub wall (114) thus allowing slipping of the opposite elongated end to be slipped underneath the hub wall and aligning the insert structure such that the two substantially flat wing or loop like elements (107A) of the support structure rest on the edge (115) of the center bore.

According to certain aspects the support structure is a wire bar having the flat wing or loop like elements (107A) at the ends and a curved middle section (107B) and wherein the wire bar is configured to be mounted underneath the insert ring such that the flat wing or loop like elements are arranged on the outer circumference (117) of the insert ring (106) opposite to each other at locations defined by a short diameter of the outer circumference and extending outward away from the central hole (109) of the insert ring.

According to certain aspects the insert ring has grooves (113) on the outer circumference (117) at locations defined by the short diameter and the wire bar is configured to be inserted into the grooves.

According to certain aspects the support structure is an integral part of the insert ring (106) such that the flat wing or loop like elements (107A) are fixedly arranged on the outer circumference (117) of the insert ring (106) opposite to each other at locations defined by a short diameter of the ring and extending outward away from the central hole (109) of the insert ring.

According to certain aspects the upper side of the insert ring (106) comprises a knob (108) configured to match a cavity in a main module (105) of the locking device such that when the main module (105) is inserted to cover the bolts/fasteners attaching the wheel of a vehicle the central hole (109) of the insert ring is aligned with the axis of rotation of vehicle wheel.

### DESCRIPTION OF THE DRAWINGS

The invention is here described by means of the appended drawings on which:

FIG. 1 illustrates an exploded view of an antitheft device for preventing unauthorized access to wheel fasteners of a vehicle comprising all components of an embodiment of the locking device. The figure shows a cylinder lock (101) configured to be locked to a center bolt (103) configured to attach the insert structure (including insert ring 106 and support structure 107) to the wheel. A locking cap (102) may be included in the device and be adapted to be secured to the main module (105). An insert sleeve (104) is adapted to be inserted into the main module (105) which is configured to cover the nuts and bolts attaching the wheel to the vehicle. The support structure in this embodiment is a separate element but in certain embodiments the support structure may be fixedly incorporated to the insert ring.

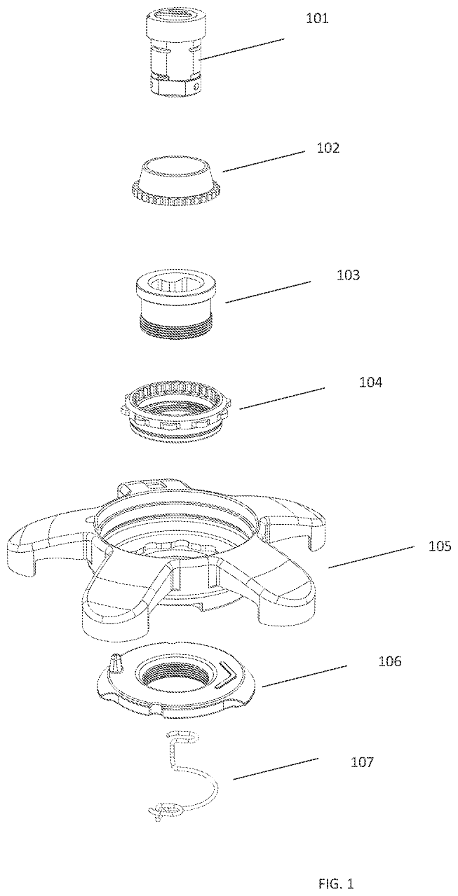

FIG. 2 illustrates a perspective view of the insert structure placed into the center bore (111) of a wheel. The insert structure is formed of the insert ring (106) and the support structure (107). The figure shows the central hole (109) of the insert ring. The support structure in this embodiment comprises two loop like elements (107A) extending outward from the outer circumference of the insert ring. The knob (108) on the upper surface of insert ring is shown.

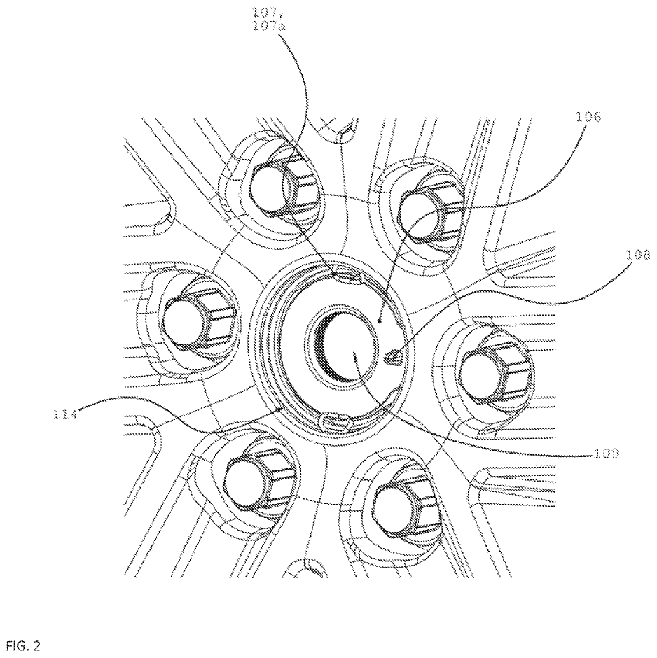

FIG. 3 illustrates a cross sectional view of the insert structure comprising insert ring (106) and support structure (107) placed in the center bore (111) of a wheel. In this embodiment the insert ring is thinner at the elongated ends, such that the inner walls (110) of the insert ring form a long threaded cylinder to attach the center bolt (element 103 in figure1). The support structure (107) in this embodiment is a wire bar that has a middle section (107B shown in FIG. 5) adjusted underneath the insert ring around the outer surface of the threaded cylinder of the insert ring. According to other embodiments there could be a groove in the bottom side of the insert ring adapted to receive the middle section of the wire bar. The elongated insert ring may be oval in its shape, but it may also have some other elongated form. It may be symmetrical or unsymmetrical.

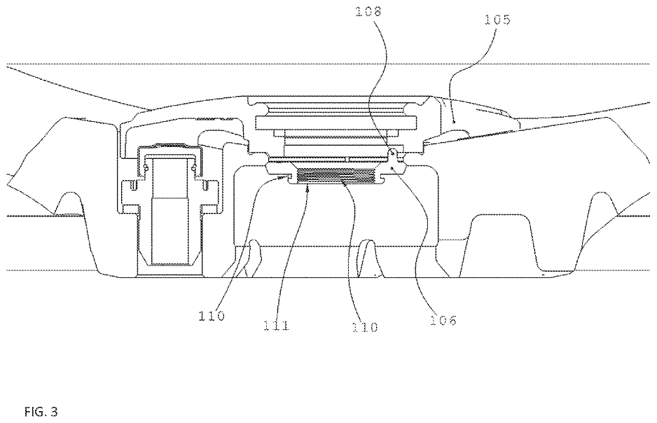

FIG. 4 illustrates a top perspective view of the insert structure. Here the inner walls of the insert ring are shown to be threaded. The upper side of the insert structure has a knob (108) fitting into a cavity of the main module (element 5 in FIG. 1) to align the insert structure. The insert ring (106) has an elongated outer circumference (117) defined by a short and a long diameter. Elongated ends of the insert ring are indicated as element 112. The support structure in this embodiment is a wire bar that has two loop like ends (107A) opposite to each other at the sides of the ring defined by the short diameter.

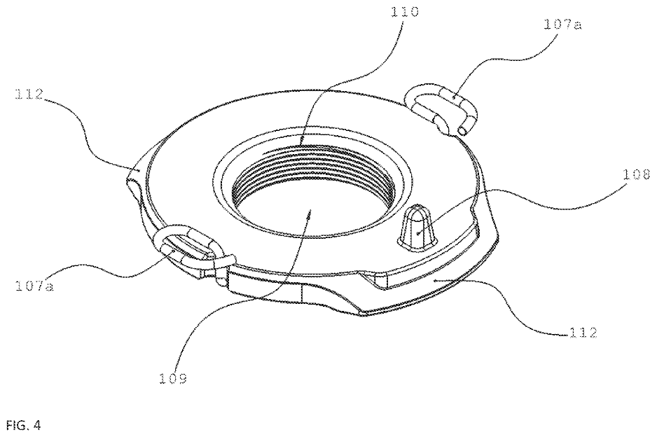

FIG. 5 shows an exploded view of the insert structure according to certain embodiments. The support structure (107) here is a wire bar having two loop like ends (107A) and a curved middle section (107B). The insert ring has two grooves (113) on the outer circumference opposite to each other at the sides of the ring defined by the short diameter. The support structure is configured to be attached to the insert ring such that the loop like ends (107A) extend outward from the grooves (113) and the curved middle section (107B) is underneath the insert ring around the outer surface of the threaded cylinder of the insert ring or inside a groove at the bottom of the insert ring.

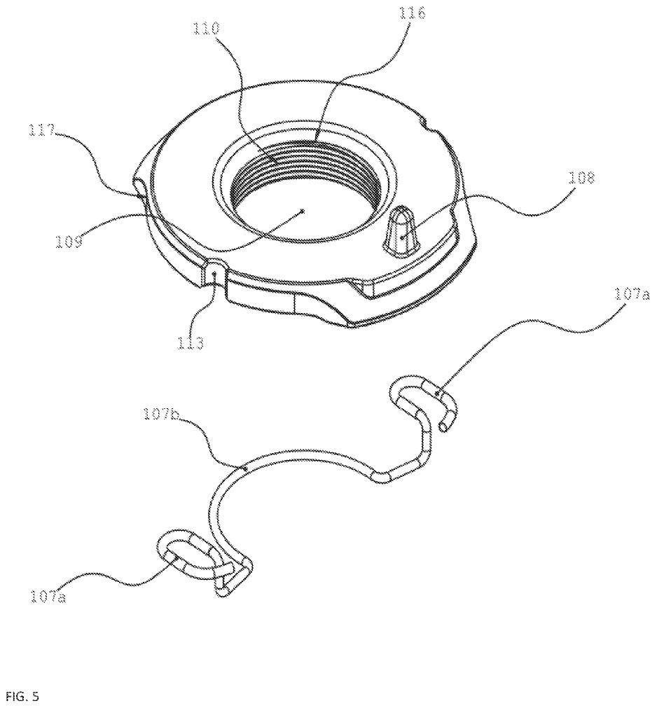

FIG. 6 shows installation of the insert structure into the vehicle wheel. The insert structure (insert ring 106 and support structure 107) is tilted in an angle downward such that the one elongated end (112) can be slipped underneath the wall of the wheel hub (114). Upon pushing the insert structure deeper, the opposite elongated end can be slipped under the wall of the wheel hub (114). The support structure (here a wire bar with loop like ends and middle section around the tubular area outer side of the threaded cylinder of the insert ring) is configured to fall on the edge (115 in FIG. 7) of the wheel bore and thus prevent the insert structure to fall inside the bore.

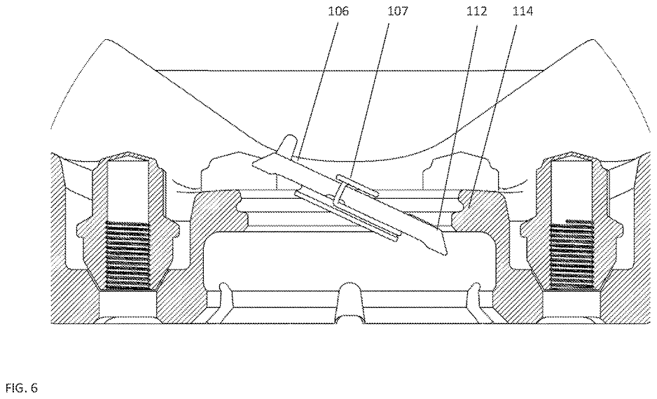

FIG. 7 shows the insert structure in its place. The elongated ends (112) of the insert ring are on against the inner side of the wall of the wheel hub (114) preventing pulling the insert structure out from its place. The support structure sits on the edge of the central bore (115) preventing the insert structure to fall or be pushed into the central bore. The knob (108) points outward and is configured to fit in a cavity in the main module (105) such that that when the main module is mounted on its place the central hole (109) of the insert ring is aligned with the axis of rotation of vehicle wheel, and allowing the threading of the insert ring and the threading of the locking bolt to match each other.

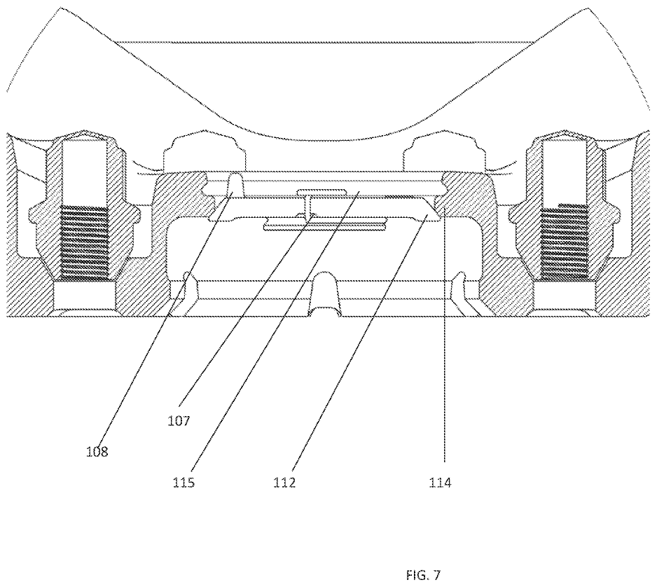

### ELEMENT NUMBERS

101 cylindrical lock
102 locking cap
103 center bolt
104 insert sleeve
105 main module
106 insert ring
107 support structure
107A loop or wing like end of the support structure
107B curved middle section of the support structure
108 knob
109 central hole
110 threaded inner walls of insert ring
111 center bore of a wheel
112 elongated end of the insert ring
113 groove
114 hub wall
115 edge of the central bore

What is claimed is:

1. An antitheft device for locking a wheel of a vehicle, comprising:
a main module (105) adapted to be attached to the wheel, and configured to cover nuts or bolts attaching the wheel;
an insert structure comprising an insert ring (106) and a support structure (107),
the insert ring having a central hole (109) and an outer (116) and an inner (117) circumference; wherein
the inner circumference (116) of the ring is threated, the threading being adapted to match threading of a center bolt (103) configured to adapt a cylindrical lock (101) adapted to prevent the center bolt (103) rotating relative to the insert structure when the locking device is in a locked position,
the outer circumference (117) of the insert ring being elongated and defined by a short diameter being smaller than a diameter of a central bore (111) of the wheel, and a long diameter perpendicular to the short diameter and being larger than the diameter of the central bore, the insert ring thus having two elongated ends (112) opposite to each other, and optionally two grooves (113) opposite to each other in locations defined by the short diameter in between of the elongated ends,
the support structure (107) having two flat wing or loop like elements (107A) configured to extend outward from the outer circumference (117) of the insert ring (106) on opposite sides of the outer circumference (117) at locations defined by the short diameter,
the insert structure being configured to be inserted into the center bore of the wheel (111) in an angle such that a first elongated end is slipped under the hub wall (114) allowing the opposite elongated portion to be slipped under the hub wall and allowing the flat wing or loop like elements (107A) of the support structure to sit on an edge (115) of the central bore supporting the insert structure.

2. The device according to claim 1, wherein the insert structure is a wire bar having the flat wing or loop like elements (107A) at the ends of the bar, and wherein the wire bar is configured to be mounted underneath the insert ring (106), such that the flat wing or loop like elements extend outward from the outer circumference (117) of the insert ring (106) on opposite sides of the outer circumference at locations defined by the short diameter, and wherein the wire bar is preferably inserted into the grooves (113) on the outer circumference.

3. The device according to claim 1, wherein the support structure is an integral part of the insert ring and consists of two flat wing or loop like elements extending outward from the outer circumference of the insert ring on opposite sides of the outer circumference at locations defined by the short diameter.

4. An insert structure configured to be fitted into a center bore (111) of a vehicle wheel and to extend partially underneath a hub wall (114) for attaching an antitheft locking device preventing unauthorized access to fasteners of the wheel, wherein the insert structure comprises:
an elongated insert ring (106) having a substantially flat upper surface, a round central hole (109), and an outer circumference (117) defined by a short diameter being smaller than a diameter of a central bore (111) of the wheel, and a long diameter perpendicular to the short diameter and being larger than the diameter of the central bore (111), and
a support structure (107) configured to support the insert ring against an edge (115) of the center bore;
the central hole (109) being dimensioned to receive a center bolt (103) of the locking device, and having a threaded inner surface (110) configured to match a threading of the center bolt;
the support structure comprising two substantially flat elements (107A) arranged on the outer circumference (117) of the insert ring opposite to each other at locations defined by a short diameter of the outer circumference (117) and extending outward away from the central hole (109) of the insert ring; and wherein
the insert structure is configured to be inserted above the center bore (111) in an angled position by inserting one of the elongated ends (112) first such that the inserted end slips underneath the hub wall (114) thus allowing slipping of the opposite elongated end to be slipped underneath the hub wall and aligning the insert structure such that the two substantially flat elements (107b) of the support structure rest on the edge (115) of the center bore.

5. The insert structure of claim 4, wherein the support structure is a wire bar having the flat wing or loop like elements (107A) at the ends and a curved middle section (107B) and wherein the wire bar is configured to be mounted underneath the insert ring such that the flat wing or loop like elements are arranged on the outer circumference (117) of the insert ring (106) opposite to each other at locations defined by a short diameter of the outer circumference and extending outward away from the central hole (109) of the insert ring.

6. The insert structure of claim 4, wherein the insert ring has grooves (113) on the outer circumference (117) at locations defined by the short diameter and the wire bar is configured to be inserted into the grooves.

7. The insert structure of claim 4, wherein the support structure is an integral part of the insert ring (106) such that the flat wing or loop like elements (107A) are fixedly arranged on the outer circumference (117) of the insert ring (106) opposite to each other at locations defined by a short diameter of the ring and extending outward away from the central hole (109) of the insert ring.

8. (canceled)

9. The device according to claim 2, wherein the support structure is an integral part of the insert ring and consists of two flat wing or loop like elements extending outward from the outer circumference of the insert ring on opposite sides of the outer circumference at locations defined by the short diameter.

10. The insert structure of claim 5, wherein the insert ring has grooves (113) on the outer circumference (117) at locations defined by the short diameter and the wire bar is configured to be inserted into the grooves.

11. The insert structure of claim 5, wherein the support structure is an integral part of the insert ring (106) such that the flat wing or loop like elements (107A) are fixedly arranged on the outer circumference (117) of the insert ring (106) opposite to each other at locations defined by a short diameter of the ring and extending outward away from the central hole (109) of the insert ring.
